(19) United States
(12) Patent Application Publication
(10) Pub. No.: US 2011/0087382 A1
(43) Pub. Date: Apr. 14, 2011

(54) PROCESS FOR MANAGING AND CURTAILING POWER DEMAND OF APPLIANCES AND COMPONENTS THEREOF

(75) Inventors: Gianpiero Santacatterina, Sangiano (IT); Matteo Santinato, Albignasego (IT); Ettore Arione, Leggiuno (IT); Rocco Petrigliano, Valsinni (IT)

(73) Assignee: WHIRLPOOL CORPORATION, Benton Harbor, MI (US)

(21) Appl. No.: 12/973,287

(22) Filed: Dec. 20, 2010

Related U.S. Application Data
(63) Continuation of application No. 12/821,644, filed on Jun. 23, 2010.
Application No. 12/821,644 is a continuation of application No. 10/757,891, filed on Jan. 15, 2004, now abandoned.

(30) Foreign Application Priority Data
Jan. 21, 2003 (EP) 03001238.9

(51) Int. Cl. G06F 1/26

(52) U.S. Cl. 700/291

(57) ABSTRACT

A process for managing power demand of simultaneously operating appliances some of which are capable of executing multiple cycles of operation.

### CROSS REFERENCE TO RELATED APPLICATIONS

The present application is a continuation of U.S. patent application Ser. No. 12/821,644, filed Jun. 23, 2010, which is a continuation of U.S. patent application Ser. No. 10/757,891, filed Jan. 15, 2004, which claims the benefit of European Patent Application No. 03001238.9, filed Jan. 21, 2003, both of which are incorporated by reference in their entirety.

### BACKGROUND OF THE INVENTION

1. Field of the Invention

The present invention relates to a process and a system for managing and curtailing power demand of appliances and/or components thereof

2. Description of the Related Art

The main object of the present invention is to avoid or to smooth daily power peaks at utility companies. At present, utility companies react to power peaks in different ways, i.e. by increasing the energy cost during the peaks (this can be done only where different daily tariffs can be applied), by shutting-off an entire quarter when lack of power happens, and by providing home limitations on power loading (in certain countries when the power contract threshold is reached the home network is automatically disconnected from the main).

In order to efficiently curtail power absorption of appliances, the following constraints can be considered: minimize the impact on appliance performance, minimize the cost of the system, minimize the user energy cost and avoid consumer restrictions.

The process and system according to the invention are conceptually based on smoothed power absorption of loaders, co-operative participation of a great number of users, and on-line re-planning of the energy distribution on the base of power forecast.

### SUMMARY OF THE INVENTION

The invention relates to a process for managing power demands of simultaneously operating appliances, some of which are capable of executing multiple cycles of operation including a normal power consumption cycle of operation and a lower power consumption cycle of operation, where the process includes forecasting for each of the appliances a future energy consumption profile corresponding to the cycle of operation being executed, summing the future energy consumption profiles, determining if the sum indicates one or more peaks in power demand that exceeds a peak threshold, and providing a lower power consumption cycle of operation to one or more of the appliances executing a normal power consumption cycle of operation such that any peak in the power demand indicated by the sum of the future energy consumption profiles is less than the peak threshold.

### BRIEF DESCRIPTION OF THE DRAWINGS

The invention will be more apparent from the detailed description given hereinafter by way of non-limiting example with reference to the accompanying drawings, in which:

FIG. 1 is a schematic diagram showing the main functions of the power management system according to the invention;

FIGS. 2-4 show examples of on-off controls of different appliances or components thereof, and how they are combined together creating power absorption peaks when the system according to the invention is not used;

FIG. 5 shows an example of a synchronization of on-off cycles of different appliances, when a system according to the invention is used;

FIG. 6 shows schematically how the single controls of appliance components are connected to the system according to the invention;

FIG. 7 is a diagram showing how the synchronization process is carried out;

FIG. 8 shows a diagram of standard power consumption forecast compared to a reduced power consumption forecast;

FIG. 9 is a diagram showing how a power consumption profile having a high energy demand can be transformed in a new profile according to the present invention; and

FIG. 10 is a group of three graphs showing how two energy consumption profiles of different appliances can be shifted according to the invention in order to have a total energy consumption profile with lower energy demand.

### DESCRIPTION OF EMBODIMENTS OF THE INVENTION

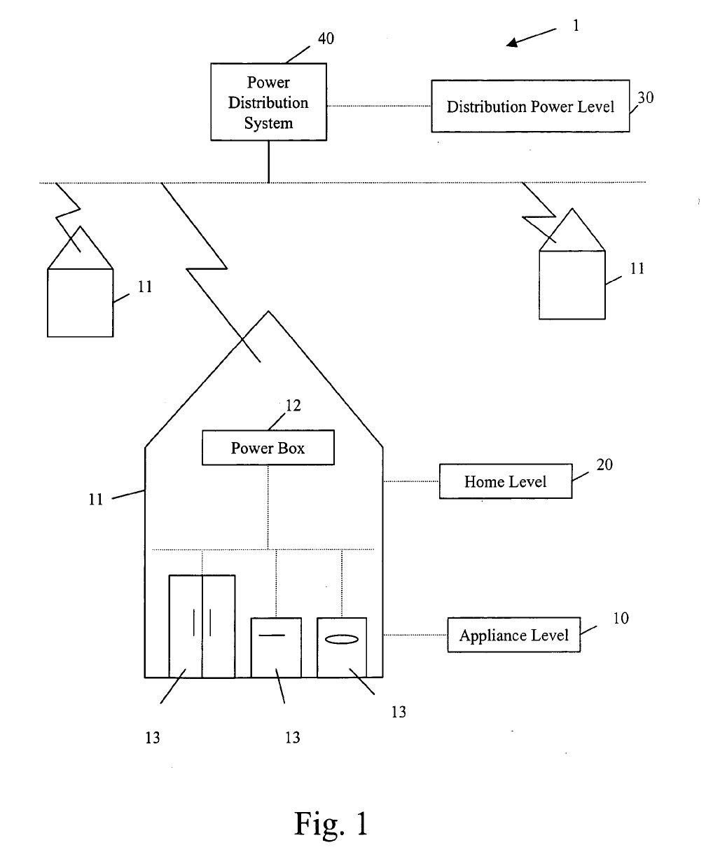

FIG. 1 shows a schematic design of the main functions of a power management system 1 according to an exemplary embodiment of the present invention. The power management system 1 involves the following three system levels: appliance level 10, home level 20 which co-ordinates all home activities and a distribution power system level 30 that manages the power distribution for all houses 11 connected to the system 1. A power control box 12 can be connected to all the appliances 13 in a house and configured to manage all the appliances. The system is based mainly on the leveling of power consumption at the appliance level 10. This solution, thanks to an efficient co-ordination of internal loads allows avoiding energy demand peaks in order to have leveled power absorption. According to the invention, the above leveling doesn't provide any limitation on appliance functionality. Another innovative feature of the system according to the present invention is the power consumption forecast. Thanks to power leveling, each appliance 13 is able to perform a more accurate prevision on power consumption in order to provide a signal on estimated future power consumption to the utility company. For each working cycle selected by the user, the appliance is able to provide alternative cycles with lower power profile (power consumption forecast), therefore, minimizing the impact on product efficiency.

At the home level 20, the system according to the invention is able to collect a power consumption forecast of the appliances 13 connected to the system 1 and collect in real time any user changes and switched-on appliances, and level home power consumption vs. time by co-ordinating in real time the appliance power loading. Thanks also to the power leveling activities, the system 1 may also be able to elaborate a home power plan forecast to be sent to the distribution power system 40. It is contemplated, the distribution power system 40 will collect forecasting for each house 11 connected to the system 1, re-organize a new forecast plan and identify on the basis of the instantaneous energy availability the directives to be sent to the connected homes 11.

The power management system 1 according to the invention can collect “on line” the utility company's directives for piloting the home power management objectives, can re-plan the appliance use on the base of the utility directives and appliance priority (meant as a sort of ranking in which the different appliances or components can be curtailed), and can negotiate with each appliance the adoption of alternative lower power consumption cycle when requested.

The possibility of changing the configuration of the system 1 is based on the following parameters at different system levels. At the appliance level 10, the system 1 can be configured on the basis of appliance priorities and/or functional priorities. As far as appliance priority is concerned, on the basis of the customer use, each appliance can have a different priority, which defines the importance of the appliance in the home network (i.e. the customer can choose the appliances that can be eventually switched off when a power reduction is required). As far as the functional priority is concerned, on the basis of user preferences, the appliance can re-arrange its predefined power saving strategy (i.e. the user can decide the importance of the hobs of its cook-top, consequently the appliance, when required, curtails the power, starting from the low priority hobs).

At home level 20, the system can be configured on the basis of contract power consumption limitation. This parameter is strictly related to the type of contract subscribed with the utility. For this reason, the special control unit of the appliance or the distinct power control box provides security features (like password and anti intrusion alarms) able to protect the setting performed by utility at contract subscription. Alternatively, this setting can be done also remotely though a connection with the utility distribution system.

According to the invention, the user can change the configuration parameters through the appliance user interface or through the interface of a distinct power control box 12. The user can directly set the appliance priority and the appliance functional priority through the appliance user interface. For this purpose, the appliance user interface is able to store the customer settings and to recognize a predefined sequence of activities. The distinct power control box 12 (which can be a home PC or a control circuit integral with an appliance) can have display features that help the customer in setting activities. Such power control box 12 could share the appliance settings (appliance priority and appliance functional priority) with the appliances 13 connected to the home network.

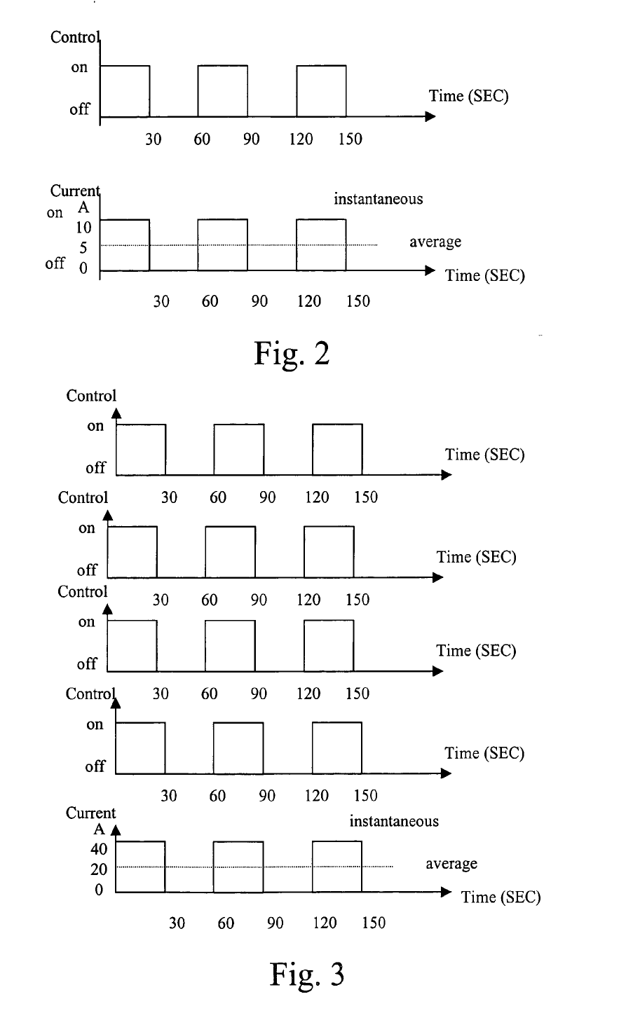

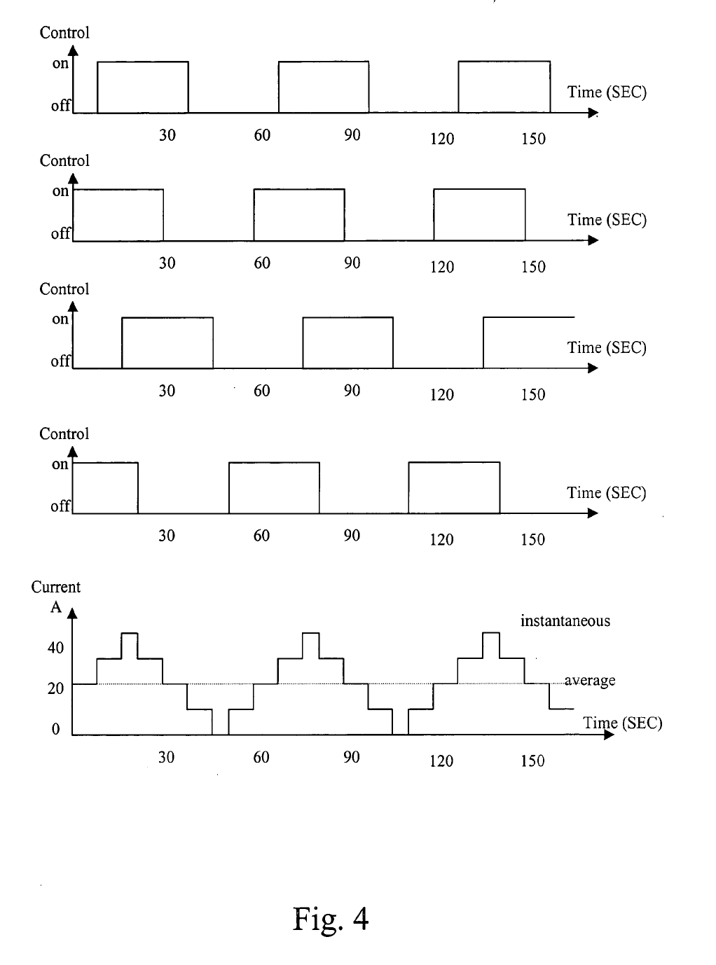

The power consumption limitation due to the particular contract between the user and the utility company can be managed directly (on line) by the utility power distribution system 40. In this case, two communication layers may be utilized: communication between the power distribution system 40 and the home power control box 12 and communication between the power control box 12 and the appliances 13. As far as the first layer is concerned, this communication can be realized on Internet support (DSL—Digital Subscriber Line, PPP—Point to Point Protocol or GSM/UMTS) or on a power line directly on the power distribution system 40. As far as the communication between the power control box 12 and the appliances 13 is concerned, for the home networking a standard communication layer can be adopted such as, but not limited to Power Line, RF, BlueTooth or the like. FIGS. 2-4 show examples of appliance energy consumption profile when the system of the present invention is not used. FIG. 5 shows an example of energy consumption profile and synchronization when appliances are connected to the system of the present invention. To better understand how the system of the present invention synchronizes the power consumption of appliances, it is important to understand the on-off cycles associated with different appliances.

The majority of the electrical appliances 13 on the market today use electro-mechanical or electronic controls to perform their functions. When the user selects a function on a product (for example a temperature level on the oven), the control “regulates” the actuator controlled (for example heaters, motors, solenoid valve, etc.) in order to reach and maintain the desired functions (for example the temperature level).

There are different methods that are used to “regulate” the actuator, depending on the type of load to be controlled (ex heaters, motors, solenoid valve, etc). The most diffused and cheaper method that is used to control the actuator, in particular the heating elements, is low frequency ON and OFF switching. This method is very simple but generates non-homogeneous current absorption from the mains. For example, if a heater with a nominal power of 2300 W@230 Vac, is switched on, it will generate a current absorption from the mains of about 10 A as shown in FIG. 2. If the control, in order to perform the required function (for example for controlling the temperature inside an oven cavity), activates the heater with a duty cycle of 50% (for example 30 sec ON and 30 sec OFF), then current absorption from the main will have a similar behavior (for example 30 sec-10 A and 30 sec-0 A.). This means that there will be current peak absorption up to 10 A, while the average current over a long period will be 5 A.

If a product with more than one actuator (for example a cooktop with 4 heaters of 2300 W each), uses the same ON-OFF control methodology for the control of each actuator, then current absorption from the mains is the sum of the single actuator current, as shown in FIG. 3. If the actuation is carried out at the same instant, a very high current is obtained when all the heaters are ON, and no current when all the heaters are OFF. For example, this means that there will be a current peak absorption up to 40 A, while the average current over a long period will be about 20 A.

Normally this does not happen and the different loads are switched ON and OFF independently (i.e. at different instants), generating current absorption that continuously changes as shown in FIG. 4 which generates noise disturbance on the mains. While the instantaneous current profile will change, with several current peaks, the average current is about the same at 20 A.

The system according to the present invention organizes the switching of the different loads in order to have an instantaneous current profile as close as possible to the average current value. This is shown in FIG. 5 where the different switching are shifted and synchronized. This creates a more homogeneous current absorption from the mains, with the following benefits: reduced noise on the mains (for example it reduces flicker), reduced current peak (with reduced stress on cables, switches and/or components, avoided mains shutdown, etc), simplified power consumption forecast and possibility to combine more products.

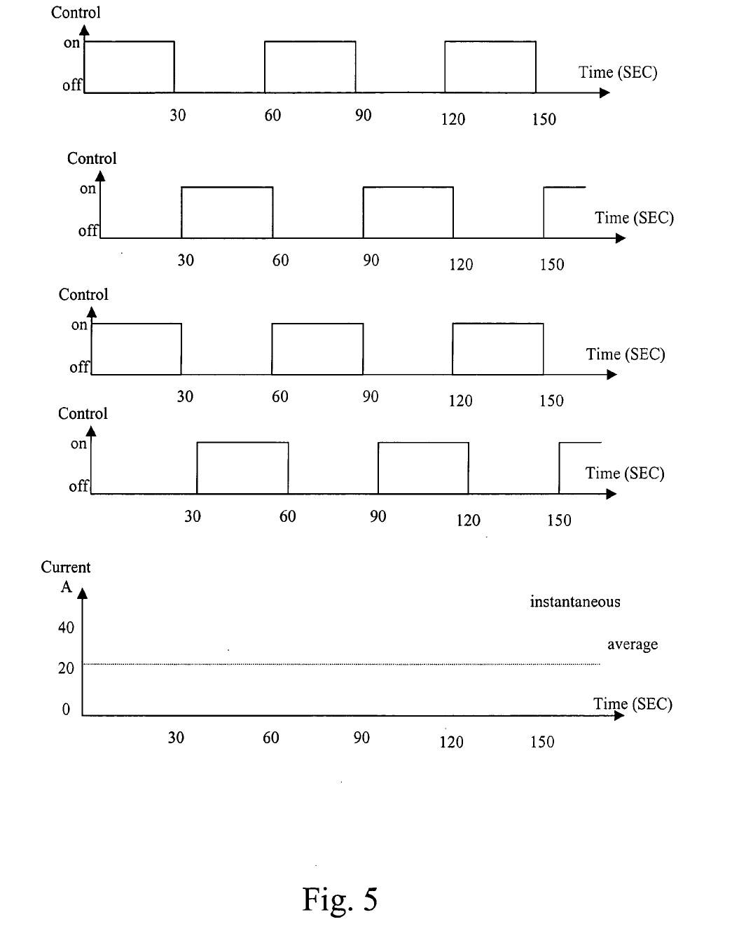

FIG. 6 shows schematically an exemplary embodiment of the present invention where the controls 14a-d of an appliance 13 are connected to the system 1 the different controls 14a-d for the different actuators 15a-d are “synchronized” by a control circuit 16 that organizes the ON-OFF switching of the single actuator in order to limit the current peak level absorption from the mains. The working parameters of the controls 14a-d are configured according to user interfaces 17a-d associated with each control 14a-d.

Each control 14a-d can decide independently the duty cycle level that needs to be applied to the relative actuator in order to reach the single objective. This information can be collected by the control circuit 16, which re-organizes the duty cycles on the right sequence and then re-sends the duty cycles to each control for the actuation. In this way it is possible to maintain different types of control strategy.

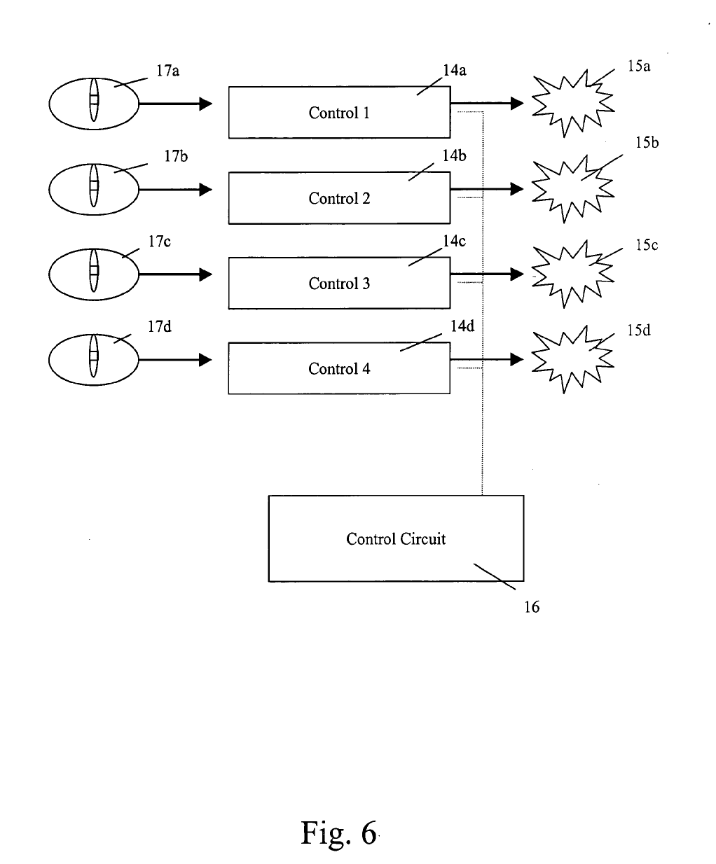

The control circuit 16 can operate in many different ways. For example, as shown in FIG. 7, each control may send to the control circuit 16 the information related to the duty cycle (D.C) 21 that it needs to apply to the related load and the nominal load power. The control circuit 16 puts in a sequence 22 all the different duty cycles starting from the one related to the load with higher power level. Then it distributes 23 them inside the selected period of control. In this way, each D.C. is placed in a precise position inside the period of control avoiding unnecessary simultaneous activation of loads. At that point, the control circuit 16 is able to calculate the power profile 24 for the next period of control. If there is a maximum power limit defined 25, the control circuit 16 can verify if it is exceeded. If yes, it can apply an algorithm 26 to reduce the maximum power limit, for example, by reducing proportionally the duty cycle of the loads, and repeat the process from D.C. re-organization. If the limit does not exist or is not exceeded, the control circuit 16 can send back to the different controls the adjusted D.C. 28 and the synchronization information (for example the phase).

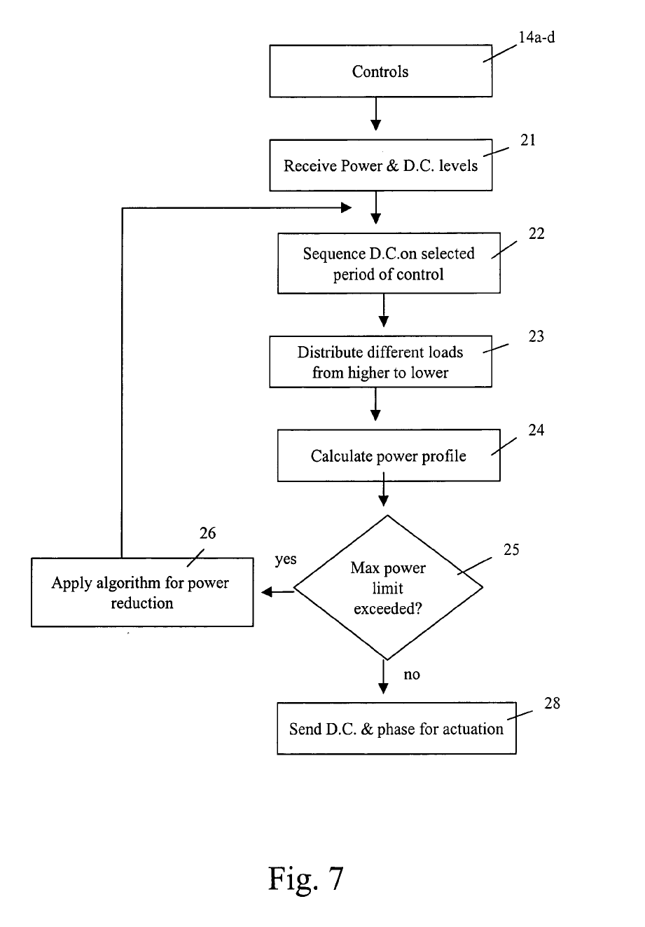

The same results can be obtained using an integrated control for the actuators. The control circuit 16 knows the power profile for the next periods of control and it is able to provide a “forecast” of the power consumption for the controlled actuators. In addition, if this information is combined with the data that each control has on its specific functionality, there can be a power consumption forecast extended for a longer period of time (for example hours or days). For example, if a cooking function, cavity temperature and duration have been selected on an oven, the system is able to provide a power consumption forecast for a long period. Additionally, each product control knows how it is possible to reduce the instantaneous power consumption based on the assessed power consumption forecast. For example, the oven control can reduce the instantaneous current absorption during the “pre-heat phase”, for example, using one heating element less but increasing the heat up time. In this way, the system can provide, in addition to the “normal power consumption forecast”, also a potential “reduced power consumption forecast” as shown in the attached FIG. 8. This information can be used by a power control box to plan a reduction on the power consumption peak of a group of appliances when required.

When a centralized control unit, or power control box 12, is used to coordinate more appliances in a house, an algorithm running inside the control unit may take into consideration many factors to optimize the leveling feature. The information can have more sources such as power distribution network, a power meter device (installed to read the energy consumption of some/all devices switched on), and a new generation of appliances able to communicate with external device like power control box, and to apply power leveling itself with a low degradation of their performances.

The power control box collects all the information coming from each appliance to elaborate the house power forecast and it can also negotiate the more suitable power profiles with every appliance to level the total power absorption.

The information collected can be delivered to the distribution power network, to give a general forecast of power consumption and to allow the utility company to actuate the power leveling, managing each house connected.

The utility company can suggest reducing the power consumption during some hours of the day, by offering a dedicated contract or special tariffs to the customer. The power control box is able to elaborate the energy directives coming from the power network and apply them negotiating the consumption forecast with the appliances and following the priorities chosen by customer.

According to a further embodiment of the invention, the leveling of power consumption can also be obtained through a proper time scheduling of the appliances. Most white appliances, performing their working cycles, have some functionality that can be delayed to save energy. A typical example is the refrigerator or freezer. This appliance normally performs one or some defrost cycles during the day. This particular functionality gives the possibility to save energy scheduling such defrost during the night or when energy is available at low cost. According to such embodiment, the power control box 12 can ask to inhibit more functionality of some appliances in order to achieve power saving in critical situation: the ice producer can be stopped, the same for freezer compressor or washer spinning cycle for short time and so on.

According to a further embodiment of the invention, each appliance may be asked to elaborate a power saving forecast. So, the power control box 12 can ask every appliance to give more forecast shapes, over the default power shape, depending from the program presently running. The leveling algorithm on the power control box can command, in real time, the appliance to switch from different power shapes if it is unable to obtain a good leveling only by time shifting or time scheduling.

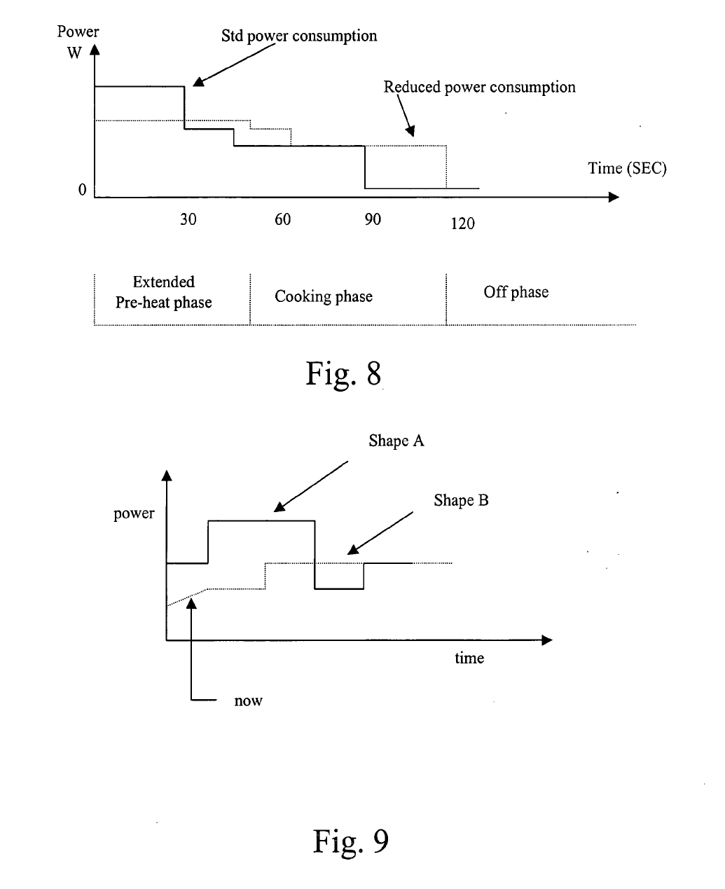

With reference to FIG. 9, the diagram gives and idea of two different forecasts of power demand coming from the same appliance. The B shape (in dotted line) requires less power consumption compared to A. Changing the power curve from A to B will modify the performance of the appliance involved. An electric oven, for example, can take more time to reach the correct temperate set, but it is always able to cook the food. So, the power saving curve B on the graph is acceptable in emergency situation.

From the user interface point of view, the power control box 12 can interact with the customer through a display (LCD or usual personal computer running a dedicate software) to re-define the default setting or change the algorithm or devices priorities. It is also possible to schedule the working time of some appliances by hours of the day/days of the week etc.

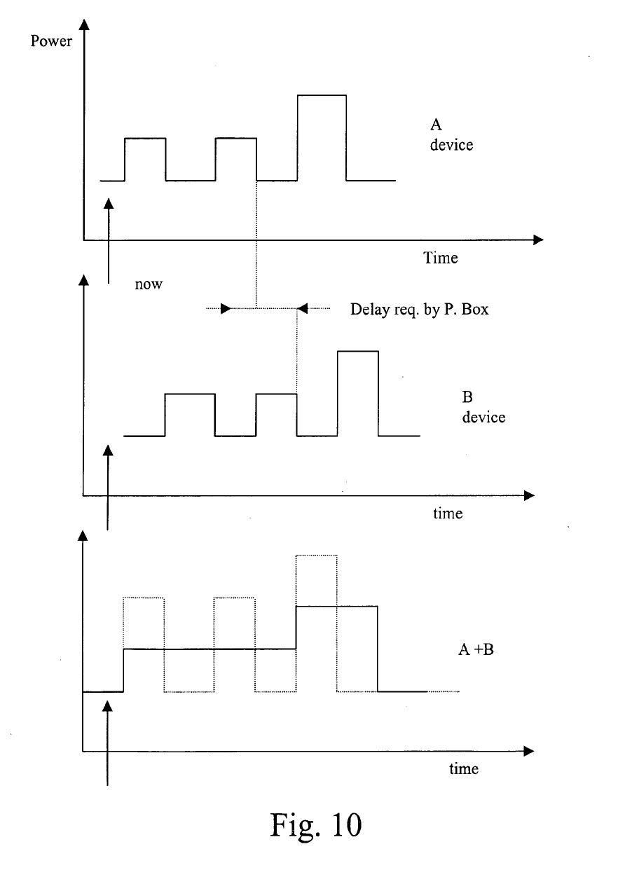

Another example of power forecast requirement is shown in FIG. 10. The upper graph for the A device explains the timing and level of power forecast needed to perform the program chosen by the user. The shape of the graph explains how the power consumption will evolve if the customer leaves the device to follow the program selected. We consider that there are two similar devices, A and B, running the same program at same time, but having a different starting time. By summing the two equal graphs, we can see the shape of the total power consumption following the dotted line on the bottom graph of FIG. 14. There are several peaks and other instants where the power demand is low because the two devices aren't well synchronized. A possible action, in this situation, for the leveling algorithm running inside the power control box is to negotiate with the device B to delay his power peaks when the A device requires the minimal level of energy. The delayed “thick” shape on graph B where the appliance is well synchronized with the appliance A is shown in the middle graph of FIG. 14 and the total power shape needed to run the two devices is shown on bottom graph with thick line. Comparing the two cumulative power curves, the first dotted and the other thick (on the bottom graph), it's possible to detect the advantage of using leveling technology. As the utility company can save money without activate more power plants to supply strong peaks of power demand, the user can stay inside his power limits and reduce the possibility of dangerous blackout overcoming limits inside his house. The algorithm of the power control box can check the effective availability of energy before switching on a new appliance in order to avoid black out.

The distribution power system manages the power distribution like an on line stock. Its goal is to avoid the power peaks minimizing at the same time the impact on the user (and avoiding the shut-off of entire quarter). It can reach its objective exploiting two main concepts: the advance management of the forecasted power (forecasted power availability on one side and forecasted power request on the other side) and the collaboration with appliances (power absorption leveling and power reduction).

What is claimed is:

1. A process for managing power demand of simultaneously operating appliances, some of which are capable of executing multiple cycles of operation including a normal power consumption cycle of operation and a lower power consumption cycle of operation, the process comprising:
forecasting for each of the appliances a future energy consumption profile corresponding to the cycle of operation being executed;
summing the future energy consumption profiles corresponding to the cycles of operation;
determining if the sum indicates one or more peaks in power demand that exceeds a peak threshold; and
providing a lower power consumption cycle of operation to one or more of the appliances executing a normal power consumption cycle of operation such that any peak in the power demand indicated by the sum of the future energy consumption profiles is less than the peak threshold.

2. The process of claim 1, wherein the providing the lower power consumption cycle of operation further comprises executing the lower power consumption cycle of operation in place of the normal power consumption cycle of operation.

3. The process according to claim 1, wherein the providing the lower power consumption cycle of operation comprises modifying at least one operating parameter of the normal power consumption cycle of operation.

4. The process according to claim 1, wherein the appliances are controlled through on-off switching and wherein the providing the lower power consumption cycle of operation comprises synchronizing the on-off switching of the appliances or components in the appliances in order to limit peaks of power demand.

5. The process according to claim 4, wherein each on-off switching is based on a duty cycle and wherein a synchronizer puts in a sequence all the duty cycles starting with the duty cycle having a load with a highest power level, then organizes them inside a selected period of control, each duty cycle being placed in a precise position inside the period of control avoiding unnecessary simultaneous activation of loads in the future.

6. The process according to claim 1, wherein the providing the lower power consumption cycle of operation is based on a delayed switching on of one of the appliances or components thereof

7. The process according to claim 6, wherein a signal, based upon the lower power consumption cycles of operation being provided to the one or more appliances, is provided to a control unit, which supervises more appliances on a main and where the signal is used by the control unit to have a forecast for future total energy consumption on the main.
